(19) United States
(12) Patent Application Publication
(10) Pub. No.: US 2024/0153474 A1
(43) Pub. Date: May 9, 2024

(54) MELODY EXTRACTION FROM POLYPHONIC SYMBOLIC MUSIC

(71) Applicant: Lemon Inc., Grand Cayman (KY)

(72) Inventors: Katerina KOSTA, London (GB); Wei Tsung LU, Los Angeles, CA (US)

(21) Appl. No.: 17/986,644

(22) Filed: Nov. 14, 2022

(30) Foreign Application Priority Data
Nov. 7, 2022 (GR) 20220100911

(51) Int. Cl. G10H 1/00

(52) U.S. Cl. CPC G10H 1/0008; G10H 1/0066; G10H 2210/061; G10H 2210/066; G10H 2210/076; G10H 2210/081; G10H 2250/311

(57) ABSTRACT

The present disclosure describes techniques for melody extraction. The techniques comprise receiving a polyphonic symbolic music file. The polyphonic symbolic music file may comprise a plurality of notes. The polyphonic symbolic music file may be converted to a plurality of feature vectors. Each of the plurality of feature vectors may be a multidimensional vector. Each of the plurality of feature vectors may correspond to a particular note of the plurality of notes. The plurality of feature vectors corresponding to the plurality of notes may be classified using a model that is trained to determine whether each of the plurality of notes belongs to a melody based on the plurality of feature vectors.

### BACKGROUND

Machine learning models are increasingly being used across a variety of industries to perform a variety of different tasks. Such tasks may include classifying data. Improved techniques for utilizing machine learning models are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for melody extraction in accordance with the present disclosure.

FIG. 2 shows an example polyphonic symbolic music representation in accordance with the present disclosure.

FIG. 3 shows an example process for melody extraction which may be performed in accordance with the present disclosure.

FIG. 4 shows another example process for melody extraction which may be performed in accordance with the present disclosure.

FIG. 5 shows another example process for melody extraction which may be performed in accordance with the present disclosure.

FIG. 6 shows an example process for pre-processing a music file which may be performed in accordance with the present disclosure.

FIG. 7 shows an example process for training and improving a melody extraction model which may be performed in accordance with the present disclosure.

FIG. 8 shows an example table illustrating performance of a model for melody extraction in accordance with the present disclosure.

FIG. 9 shows an example chart illustrating performance of a model for melody extraction in accordance with the present disclosure.

FIG. 10 shows an example set of charts illustrating performance of a model for melody extraction in accordance with the present disclosure.

FIG. 11 shows an example chart illustrating a sparsity ratio among melodies in a test set in accordance with the present disclosure.

FIG. 12 shows an example set of scatter plots illustrating pitch and duration of melody notes in accordance with the present disclosure.

FIG. 13 shows an example computing device which may be used to perform any of the techniques disclosed herein.

### DETAILED DESCRIPTION OF ILLUSTRATIVE EMBODIMENTS

Identifying melodic lines (e.g., identifying what a listener perceives to be melodies) in a piece of polyphonic music (e.g., a piece of music comprising two or more simultaneous lines of independent melodies) is an important task related to a variety of music retrieval tasks and/or musicological applications. A melodic line incorporates musical properties that are rich in contextual information, such as structure and rhythm. From a musicological point of view, being able to extract a melodic line with high accuracy can reveal new research directions related to a variety of concepts (e.g., composition style analysis, classification of performer's tendencies). In industrial or other research applications, high accuracy in melody extraction can improve the results of music search or recommendation algorithms as well as music generation systems.

However, distinguishing the melody from a piece of polyphonic music in both the audio and symbolic domains is a challenging task. For example, when listening to the piece of music, one may find it hard to distinguish note intervals from one another. For instance, an interval that is judged as a major third (e.g., a musical interval encompassing three staff positions and spanning four semitones) may, when heard by itself, be judged as fourth (e.g., a musical interval spanning four staff positions.) Thus, improved techniques for melody extraction are desirable.

Described here are improved techniques for melody extraction. A model, e.g., lightweight deep bidirectional long short-term memory (LSTM) model, may be utilized to identify the most salient melodic line of a music piece. To identify the most salient melodic line of a music piece, the model may utilize handcrafted features. For the model to identify the most salient melodic line of a music piece, the input score does not need to be separated into multiple parts. The model described herein approximates or outperforms current state of the art models trained on the same dataset based on different metrics and observations.

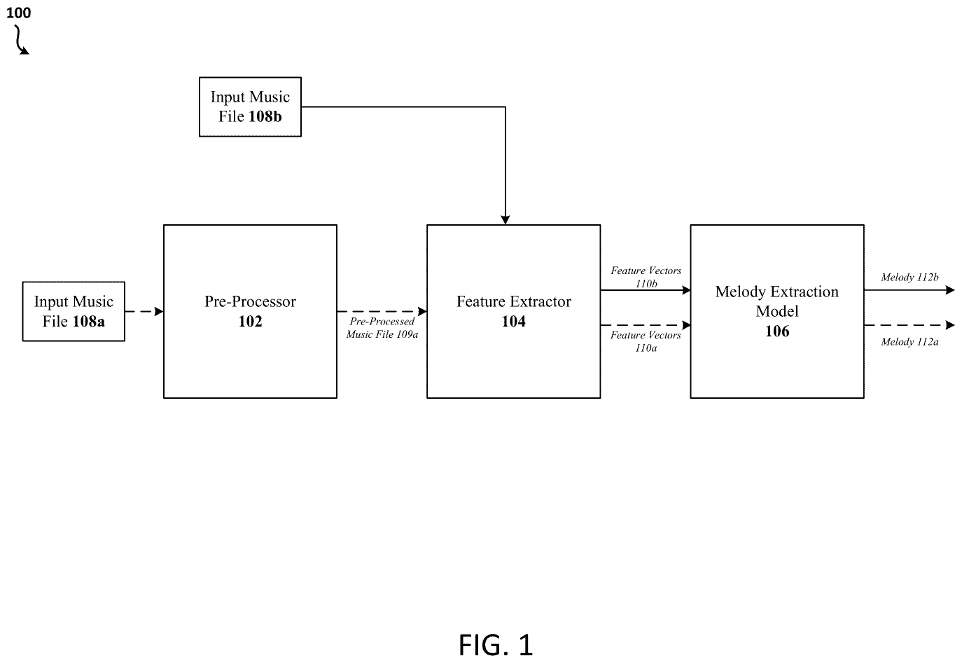

FIG. 1 illustrates an example system 100 for melody extraction. The system 100 may comprise a pre-processor 102, a feature extractor 104, and a melody extraction model 106. The melody extraction model 106 may be a supervised bidirectional long-short term-memory (biLSTM) model. The melody extraction model 106 may be a type of recurrent neural network (RNN). The melody extraction model 106 may be trained to determine whether each of a plurality of notes associated with a piece of polyphonic music (e.g., music file 108a and/or music file 108b) belongs to the melody of the piece of polyphonic music. As used herein, the term melody may refer to what a user perceives as the lead vocal melody. The remaining (e.g., non-melody) parts of the piece of polyphonic music may include for example, the bridge and the accompaniment(s).

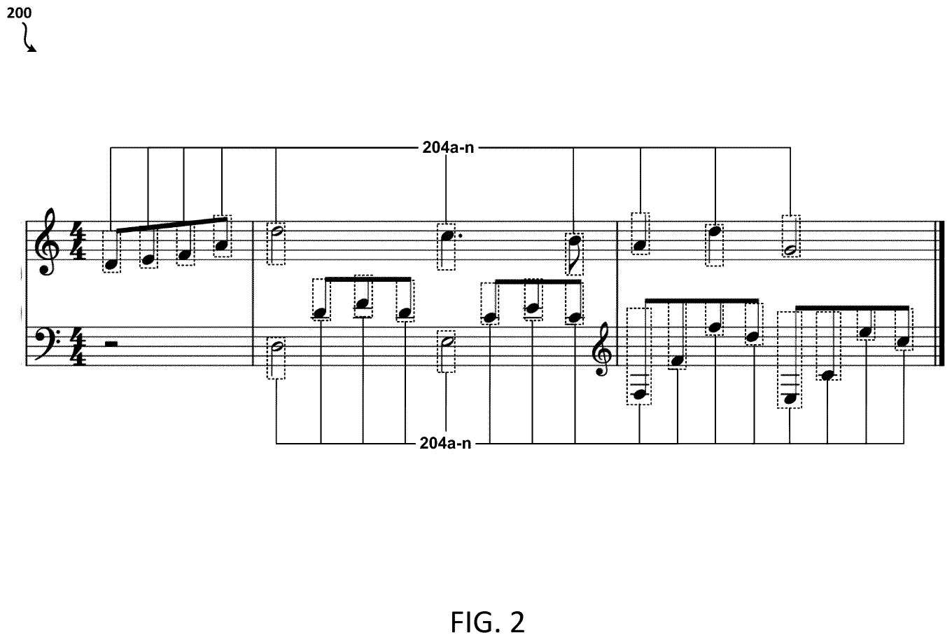

The music file 108a and the music file 108b may each comprise a musical instrument digital interface (MIDI) file. For example, the music file 108a and the music file 108b may each comprise a piece of polyphonic music stored in a MIDI format. The piece(s) of polyphonic music associated with the music file 108a or the music file 108b may be associated with a plurality of notes. FIG. 2 shows an example piece of polyphonic music 200. The piece of polyphonic music 200 comprises a plurality of notes 204a-n. The piece of polyphonic music 200 may be stored, for example, in a MIDI format. The piece of polyphonic music 200 stored in a MIDI format may be, for example, the music file 108a and/or the music file 108b. The melody extraction model 106 may be configured to determine which notes of the plurality of notes 204a-n belong to the melody of the piece of polyphonic music 200.

In embodiments, the feature extractor 104 may be configured to generate the plurality of feature vectors associated with the piece of polyphonic music. For example, the feature extractor 104 may be configured to convert the music file 108a or the music file 108b to a plurality of feature vectors 110b. In some embodiments, the music file (e.g., music file 108a) may be pre-processed by the pre-processor 102. In other embodiments, the music file (e.g., music file 108b) may not be pre-processed by the pre-processor 102. The feature extractor 104 may generate the plurality of feature vectors 110b associated with music file 108b without the music file 108b being pre-processed. Each of the plurality of feature vectors 110b associated with the music file 108b may correspond to a particular note of the plurality of notes associated with the music file 108b. Each of the plurality of feature vectors 110b may be a multi-dimensional (e.g., six-dimensional) feature vector, with each dimension of the feature vector being representative of (e.g., corresponding to) a particular feature of the corresponding note.

The features may comprise, for example, pitch, duration, absolute pitch distance below, absolute pitch distance above, onset position in bar, and pitch in scale. The pitch and duration features may contain the basic pitch and duration information of the corresponding note, respectively. The pitch feature may be expressed, for example, in a MIDI note number. The duration feature may be expressed, for example, as a crotchet level. The absolute pitch distance below feature may represent the distance to the pitch of the next (e.g., neighboring) lower note sounded simultaneously with the corresponding note. The absolute pitch distance above feature may represent the distance to the pitch of the next (e.g., neighboring) higher note sounded simultaneously with the corresponding note. The absolute pitch distance below and the absolute pitch distance above features may be expressed, for example, in semitones. The onset position in bar feature may record the score beat where the corresponding note onset is located within the score bar. The onset position in bar feature may be expressed, for example, as a crotchet level. The pitch in scale feature may record whether the pitch of the corresponding note is in the diatonic scale of the key signature. The pitch in scale feature may be expressed, for example, as a Boolean value (e.g., yes or no). These six features may be utilized to form the multidimensional feature vectors 110b associated with the music file 108b. In combination, these six features may be useful for extracting the melody from the music file 108b.

The feature vectors 110b may be utilized by the melody extraction model 106 to extract the melody 112b associated with the music file 108b. The melody extraction model 106 may be configured to receive, as input, the plurality of feature vectors 110b (e.g., a set of computed features) associated with the music file 108b. For example, the melody extraction model 106 may be configured to receive the plurality of feature vectors 110b associated with the music file 108b from the feature extractor 104. The melody extraction model 106 may utilize the plurality of feature vectors 110b associated with the music file 108b to determine whether each of the plurality of notes associated with the music file 108b belongs to the melody of the music file 108b. Determining whether each of the plurality of notes associated with the music file 108b belongs to the melody may comprise classifying each of the plurality of notes as either belonging to the melody or not belonging to the melody. For example, the melody extraction model 106 may utilize the plurality of feature vectors 110b associated with the music file 108b to extract (e.g., determine, identify, etc.) the melody from the remainder of the music file 108b.

In embodiments, a MIDI file corresponding to the melody may be constructed. The MIDI file may be constructed based on the generated classifications. For example, the MIDI file may contain all of the notes that were classified as belonging to the melody of the music file 108b. The MIDI file may not contain any of the notes that were classified as not belonging to the melody of the music file 108b.

In embodiments, the pre-processor 102 may be configured to pre-process a piece of polyphonic music before inputting a music file into the feature extractor 104 for generating the plurality of feature vectors associated with that particular piece of polyphonic music. In the example of FIG. 1, the music file 108a is pre-processed by the pre-processor 102 before the feature extractor 104 generates the plurality of feature vectors 110a associated with music file 108a. For example, the pre-processor 102 may receive the music file 108a and generate the pre-processed music file 109a based on the music file 108a. The feature extractor 104 may receive pre-processed music file 109a and generate feature vectors 110a associated with the pre-processed music file 109a. The feature vectors 110a (e.g., during training, validation, and/or application) may be utilized by the melody extraction model 106 to extract the melody 112a associated with the music file 108a.

In embodiments, to pre-process a piece of polyphonic music in MIDI form, the pre-processor 102 may be configured to read each of the plurality of notes as an event having the following attributes: start, duration, pitch, and track. All note events may be squeezed to a single list if it is determined (e.g., by the pre-processor 102) that multiple tracks exist. The pre-processor 102 may be configured to extract the time signature and/or key signature from the piece of polyphonic music. For example, the pre-processor 102 may be configured to extract the time signature and/or key signature from the piece of polyphonic music using metadata associated with the piece of polyphonic music and/or automatic extraction methods. The metadata associated with the piece of polyphonic music may indicate the beats and the key associated with the piece of polyphonic music. If a piece of polyphonic music has more than one key signature, a single key signature extracted from a music key detection algorithm may be considered.

In embodiments, the pre-processor 102 may be configured to quantize per note. Many scores include a time signature of “¼.” Thus, the pre-processor 102 may be configured to update the time signature by considering the meter information from the audio beat metadata. For example, time signatures of “ 2/4” and “2/2” may be updated to “4/4”. Also, if a score includes a misalignment in the downbeat level, the pre-processor 102 may be configured to fix the start time of the piece to reduce this issue. As the scores are performative, they may accommodate fine details or imprecision in timing. In order to setup the melody extraction model 106, a time-grid associated with the plurality of notes may be created by aligning note start times and adjusting note durations. To create the time-grid, the onset (e.g., start) time of a note may be aligned to the closest fraction with denominator 6 or 8. The duration may be adjusted to the smaller of 1) the distance of current note onset and next note onset, and 2) the current note duration in semiquaver resolution. The time-grid of the notes' onset and duration may be flexible enough to keep performative characteristics and strict enough to not explode the dimensions of possible values which would be hard to be trainable later on. The time-grid may be setup to align onset times in triplets' resolution. The note durations may be adjusted to the smaller of 1) the distance of current note onset and next note onset, and 2) the current note duration in semiquaver resolution. In embodiments, the start time of the notes may be aligned to fit the downbeat level.

The feature extractor 104 may be configured to convert the pre-processed music file 109a to a plurality of feature vectors 110a. Each of the plurality of feature vectors 110a associated with the pre-processed music file 109a may correspond to a particular note of the plurality of notes associated with the music file 108a. Each of the plurality of feature vectors 110a may be a multi-dimensional (e.g., six-dimensional) feature vector, with each dimension of the feature vector being representative of (e.g., corresponding to) a particular feature of the corresponding note.

The features may comprise, for example, pitch, duration, absolute pitch distance below, absolute pitch distance above, onset position in bar, and pitch in scale. The pitch and duration features may contain the basic pitch and duration information of the corresponding note, respectively. The pitch feature may be expressed, for example, in a MIDI note number. The duration feature may be expressed, for example, as a crotchet level. The absolute pitch distance below feature may represent the distance to the pitch of the next (e.g., neighboring) lower note sounded simultaneously with the corresponding note. The absolute pitch distance above feature may represent the distance to the pitch of the next (e.g., neighboring) higher note sounded simultaneously with the corresponding note. The absolute pitch distance below and the absolute pitch distance above features may be expressed, for example, in semitones. The onset position in bar feature may record the score beat where the corresponding note onset is located within the score bar. The onset position in bar feature may be expressed, for example, as a crotchet level. The pitch in scale feature may record whether the pitch of the corresponding note is in the diatonic scale of the key signature. The pitch in scale feature may be expressed, for example, as a Boolean value (e.g., yes or no). These six features may be utilized to form the multidimensional feature vectors 110a associated with the pre-processed music file 109a. In combination, these six features may be useful for extracting the melody from the pre-processed music file 109a.

The feature vectors 110a may be utilized by the melody extraction model 106 (e.g., during training, validation, and/or application) to extract the melody 112a associated with the pre-processed music file 109a. The melody extraction model 106 may be configured to receive, as input, the plurality of feature vectors 110a (e.g., a set of computed features) associated with the pre-processed music file 109a. For example, the melody extraction model 106 may be configured to receive the plurality of feature vectors 110a associated with the pre-processed music file 109a from the feature extractor 104. The melody extraction model 106 may utilize the plurality of feature vectors 110a associated with the pre-processed music file 109a to determine whether each of the plurality of notes associated with the music file 108a belongs to the melody of the music file 108a. Determining whether each of the plurality of notes associated with the music file 108a belongs to the melody may comprise classifying each of the plurality of notes as either belonging to the melody or not belonging to the melody. For example, the melody extraction model 106 may utilize the plurality of feature vectors 110a associated with the pre-processed music file 109a to extract (e.g., determine, identify, etc.) the melody from the remainder of the pre-processed music file 109a.

In embodiments, a MIDI file corresponding to the melody may be constructed. The MIDI file may be constructed based on the generated classifications. For example, the MIDI file may contain all of the notes that were classified as belonging to the melody of music file 108a. The MIDI file may not contain any of the notes that were classified as not belonging to the melody of the music file 108a

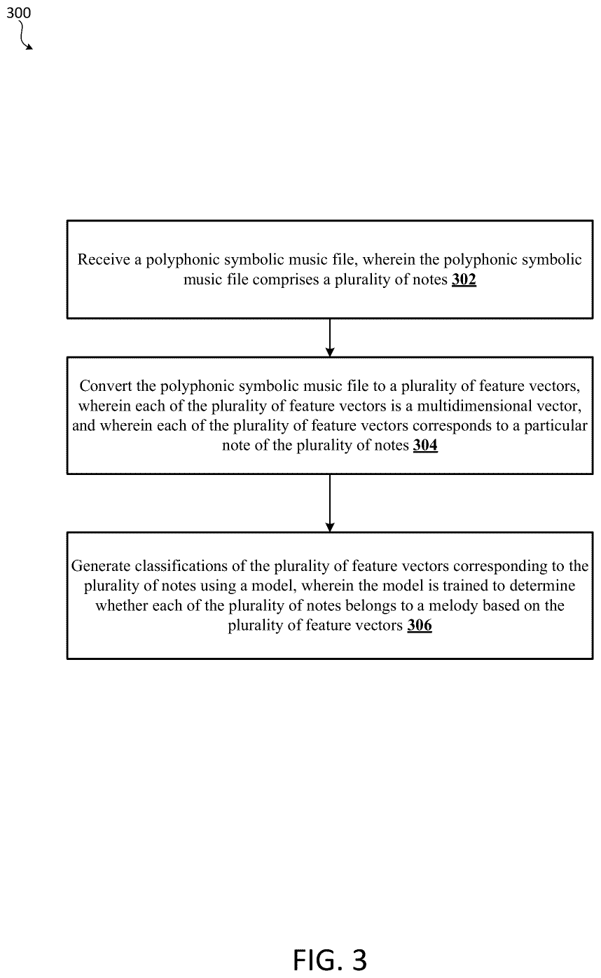

FIG. 3 illustrates an example process 300 performed by a system (e.g., system 100). The system 100 may perform the process 300 for melody extraction. Although depicted as a sequence of operations in FIG. 3, those of ordinary skill in the art will appreciate that various embodiments may add, remove, reorder, or modify the depicted operations.

At 302, a polyphonic symbolic music file (e.g., music file 108a or music file 108b) may be received. The polyphonic symbolic music file may comprise a musical instrument digital interface (MIDI) file. For example, the polyphonic symbolic music file may comprise a piece of polyphonic music stored in a MIDI format. The polyphonic symbolic music file may comprise a plurality of notes.

A melody extraction model (e.g., melody extraction model 106) may be configured to determine which notes of the plurality of notes belong to the melody of the piece of polyphonic music. The melody extraction model may be configured to receive, as input, a plurality of feature vectors associated with the piece of polyphonic music. At 304, the polyphonic symbolic music file may be converted to a plurality of feature vectors. Each of the plurality of feature vectors may corresponds to a particular note of the plurality of notes. In embodiments, a feature extractor (e.g., the feature extractor 104) may be configured to generate the plurality of feature vectors associated with the piece of polyphonic music. For example, the feature extractor may be configured to convert the polyphonic symbolic music file to a plurality of feature vectors. Each of the plurality of feature vectors may be a multi-dimensional feature vector, with each dimension of the feature vector being representative of (e.g., corresponding to) a particular feature of the corresponding note. The features may comprise, for example, pitch, duration, absolute pitch distance below, absolute pitch distance above, onset position in bar, and pitch in scale.

To determine whether each of the plurality of notes associated with the piece of polyphonic music belongs to the melody of the piece of polyphonic music, a model (e.g., the melody extraction model 106) may utilize the plurality of feature vectors associated with the piece of polyphonic music. At 306, classifications of the plurality of feature vectors corresponding to the plurality of notes may be generated using a model. The model may be trained to determine whether each of the plurality of notes belongs to a melody. Determining whether each of the plurality of notes belongs to a melody may be based on the plurality of feature vectors. Determining whether each of the plurality of notes associated with the piece of polyphonic music belongs to the melody of the piece of polyphonic music may comprise classifying each of the plurality of notes as either belonging to the melody or not belonging to the melody. For example, the melody extraction model may utilize the plurality of feature vectors associated with the piece of polyphonic music to extract (e.g., determine, identify, etc.) the melody from the remainder of the piece of polyphonic music.

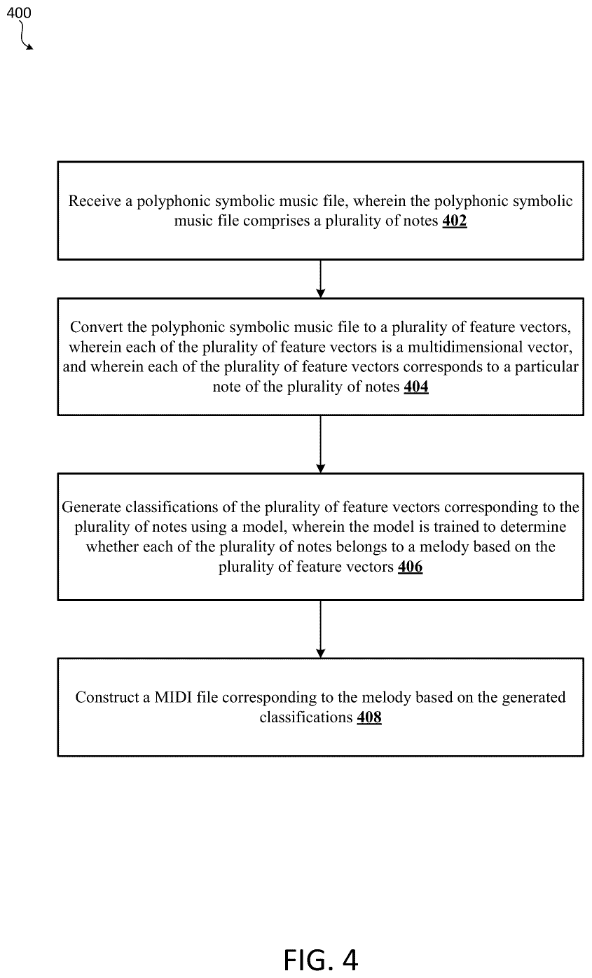

FIG. 4 illustrates an example process 400 performed by a system (e.g., system 100). The system 100 may perform the process 400 for melody extraction. Although depicted as a sequence of operations in FIG. 4, those of ordinary skill in the art will appreciate that various embodiments may add, remove, reorder, or modify the depicted operations.

At 402, a polyphonic symbolic music file (e.g., music file 108a or music file 108b) may be received. The polyphonic symbolic music file may comprise a musical instrument digital interface (MIDI) file. For example, the polyphonic symbolic music file may comprise a piece of polyphonic music stored in a MIDI format. The polyphonic symbolic music file may comprise a plurality of notes.

A melody extraction model (e.g., melody extraction model 106) may be configured to determine which notes of the plurality of notes belong to the melody of the piece of polyphonic music. The melody extraction model may be configured to receive, as input, a plurality of feature vectors associated with the piece of polyphonic music. At 404, the polyphonic symbolic music file may be converted to a plurality of feature vectors. Each of the plurality of feature vectors may corresponds to a particular note of the plurality of notes. In embodiments, a feature extractor (e.g., the feature extractor 104) may be configured to generate the plurality of feature vectors associated with the piece of polyphonic music. For example, the feature extractor may be configured to convert the polyphonic symbolic music file to a plurality of feature vectors. Each of the plurality of feature vectors may be a multi-dimensional feature vector, with each dimension of the feature vector being representative of (e.g., corresponding to) a particular feature of the corresponding note. The features may comprise, for example, pitch, duration, absolute pitch distance below, absolute pitch distance above, onset position in bar, and pitch in scale.

To determine whether each of the plurality of notes associated with the piece of polyphonic music belongs to the melody of the piece of polyphonic music, a model (e.g., the melody extraction model 106) may utilize the plurality of feature vectors associated with the piece of polyphonic music. At 406, classifications of the plurality of feature vectors corresponding to the plurality of notes may be generated using a model. The model may be trained to determine whether each of the plurality of notes belongs to a melody. Determining whether each of the plurality of notes belongs to a melody may be based on the plurality of feature vectors. Determining whether each of the plurality of notes associated with the piece of polyphonic music belongs to the melody of the piece of polyphonic music may comprise classifying each of the plurality of notes as either belonging to the melody or not belonging to the melody. For example, the melody extraction model may utilize the plurality of feature vectors associated with the piece of polyphonic music to extract (e.g., determine, identify, etc.) the melody from the remainder of the piece of polyphonic music.

At 408, a MIDI file corresponding to the melody may be constructed. The MIDI file may be constructed based on the generated classifications. For example, the MIDI file may contain all of the notes that were classified as belonging to the melody of the piece of polyphonic music. The MIDI file may not contain any of the notes that were classified as not belonging to the melody of the piece of polyphonic music. The constructed MIDI file may be used for music generation, music search, and/or music recommendation algorithms, etc.

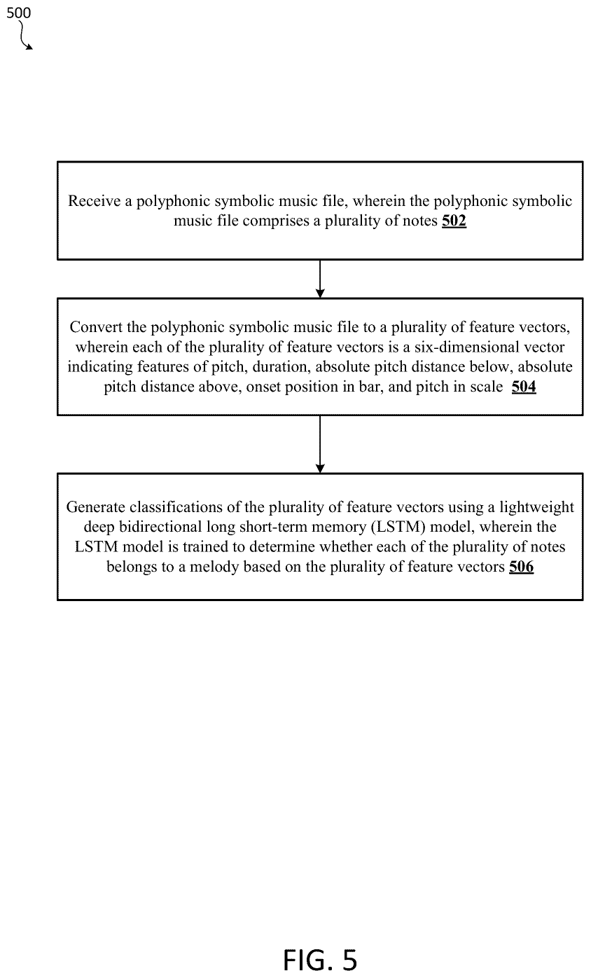

FIG. 5 illustrates an example process 500 performed by a system (e.g., system 100). The system 100 may perform the process 500 for melody extraction. Although depicted as a sequence of operations in FIG. 5, those of ordinary skill in the art will appreciate that various embodiments may add, remove, reorder, or modify the depicted operations.

At 502, a polyphonic symbolic music file (e.g., music file 108a or music file 108b) may be received. The polyphonic symbolic music file may comprise a musical instrument digital interface (MIDI) file. For example, the polyphonic symbolic music file may comprise a piece of polyphonic music stored in a MIDI format. The polyphonic symbolic music file may comprise a plurality of notes.

A melody extraction model (e.g., melody extraction model 106) may be configured to determine which notes of the plurality of notes belong to the melody of the piece of polyphonic music. The melody extraction model may be configured to receive, as input, a plurality of feature vectors associated with the piece of polyphonic music. At 504, the polyphonic symbolic music file may be converted to a plurality of feature vectors. Each of the plurality of feature vectors may corresponds to a particular note of the plurality of notes. In embodiments, a feature extractor (e.g., the feature extractor 104) may be configured to generate the plurality of feature vectors associated with the piece of polyphonic music. For example, the feature extractor may be configured to convert the polyphonic symbolic music file to a plurality of feature vectors. Each of the plurality of feature vectors may be a six-dimensional feature vector, with each dimension of the feature vector being representative of (e.g., corresponding to) a particular feature of the corresponding note. The features may comprise, for example, pitch, duration, absolute pitch distance below, absolute pitch distance above, onset position in bar, and pitch in scale.

To determine whether each of the plurality of notes associated with the piece of polyphonic music belongs to the melody of the piece of polyphonic music, a model (e.g., the melody extraction model 106) may utilize the plurality of feature vectors associated with the piece of polyphonic music. At 506, classifications of the plurality of feature vectors corresponding to the plurality of notes may be generated using a model. The model may be a lightweight deep bidirectional long short-term memory (LSTM) model. The model may be trained to determine whether each of the plurality of notes belongs to a melody. Determining whether each of the plurality of notes belongs to a melody may be based on the plurality of feature vectors. Determining whether each of the plurality of notes associated with the piece of polyphonic music belongs to the melody of the piece of polyphonic music may comprise classifying each of the plurality of notes as either belonging to the melody or not belonging to the melody. For example, the melody extraction model may utilize the plurality of feature vectors associated with the piece of polyphonic music to extract (e.g., determine, identify, etc.) the melody from the remainder of the piece of polyphonic music.

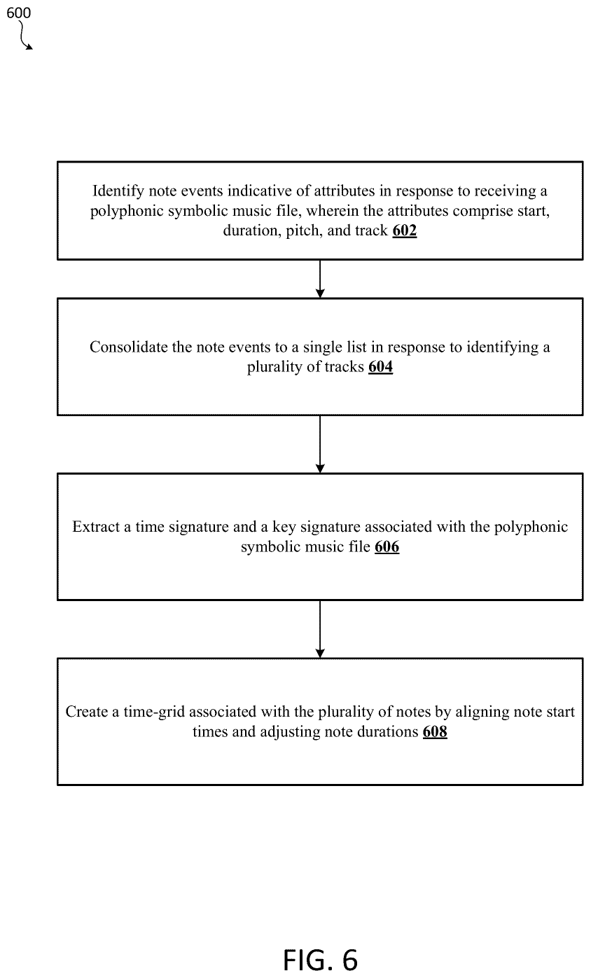

FIG. 6 illustrates an example process 600 performed by a system (e.g., system 100). The system 100 may perform the process 600 for pre-processing a music file. Although depicted as a sequence of operations in FIG. 6, those of ordinary skill in the art will appreciate that various embodiments may add, remove, reorder, or modify the depicted operations.

To pre-process a piece of polyphonic music in MIDI form, a pre-processor (e.g., pre-processor 102) may be configured to read each of the plurality of notes as an event having the following attributes: start, duration, pitch, and track. At 602, note events may be identified. The note events may be indicative of attributes. The attributes may comprise, for example, start, duration, pitch, and track. The note events may be identified in response to receiving a polyphonic symbolic music file. All note events may be squeezed to a single list if it is determined (e.g., by the pre-processor 102) that multiple tracks exist. At 604, the note events may be consolidated to a single list. The note events may be consolidated to a single list in response to identifying a plurality of tracks

The time signature and/or key signature may be extracted from the piece of polyphonic music. At 606, a time signature and a key signature associated with the polyphonic symbolic music file may be extracted. The time signature and/or key signature may be extracted from the piece of polyphonic music using metadata associated with the piece of polyphonic music and/or automatic extraction methods. The metadata associated with the piece of polyphonic music may indicate the beats and the key associated with the piece of polyphonic music. If a piece of polyphonic music has more than one key signature, a single key signature extracted from a music key detection algorithm may be considered. For example, many scores include a time signature of “¼.” Thus, the time signature may be updated by considering the meter information from the audio beat metadata. For example, time signatures of “ 2/4” and “2/2” may be mapped to “4/4”. Also, if a score includes a misalignment in the downbeat level, the start time of the piece may be fixed to reduce this issue. As the scores are performative, they may accommodate fine details or imprecision in timing.

In order to setup the model, a time-grid associated with the plurality of notes may be created by aligning note start times and adjusting note durations. At 608, a time-grid may be created. The time-grid may be associated with the plurality of notes. The time-grid may be created by aligning note start times and adjusting note durations. To create the time-grid, the onset (e.g., start) time of a note may be aligned to the closest fraction with denominator 6 or 8. The duration may be adjusted to the smaller of 1) the distance of current note onset and next note onset, and 2) the current note duration in semiquaver resolution. The time-grid of the notes' onset and duration may be flexible enough to keep performative characteristics and strict enough to not explode the dimensions of possible values which would be hard to be trainable later on. The time-grid may be setup to align onset times in triplets' resolution. The note durations may be adjusted to the smaller of 1) the distance of current note onset and next note onset, and 2) the current note duration in semiquaver resolution. In embodiments, the start time of the notes may be aligned to fit the downbeat level.

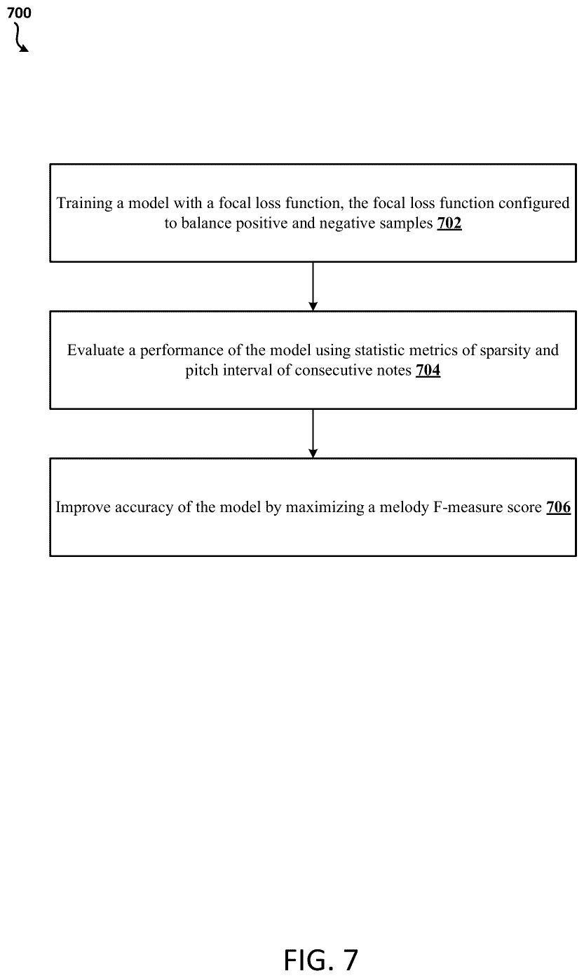

FIG. 7 illustrates an example process 700 performed by a system (e.g., system 100). The system 100 may perform the process 700 for training and improving a melody extraction model. Although depicted as a sequence of operations in FIG. 7, those of ordinary skill in the art will appreciate that various embodiments may add, remove, reorder, or modify the depicted operations.

A training dataset used to train a melody extraction model (e.g., melody extraction model 106) may be associated with an imbalance of data labels (e.g., the two classification classes may be imbalanced in the training data set). For example, notes not belonging to the melody may outnumber the notes belonging to the melody. To overcome this issue, the focal loss (e.g., Equation 1) may be adopted as the loss function for the melody extraction model 106. At 702, a model may be trained with a focal loss function. The focal loss function may be configured to balance positive and negative samples. The focal loss may be defined as:

FL(pₜ)=−aₜ(1−pₜ)^{γ} log(pₜ), Equation 1

where pₜ denotes an estimated probability of the melody extraction model 106 classifying an input to class t, aₜ∈[0,1] is a weighting factor to balance the positive and negative samples during training the melody extraction model 106, (1−pₜ)^{γ} is a modulating factor with γ controlling a rate at which over-weighted samples are down weighted. aₜ may be set to a value of 0.25 and y may be set to a value of 2.

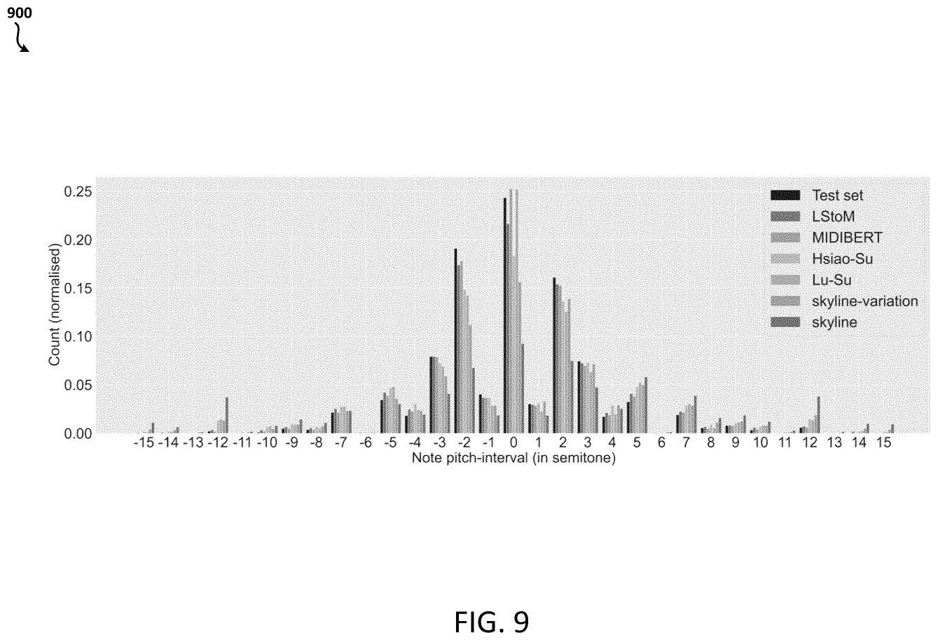

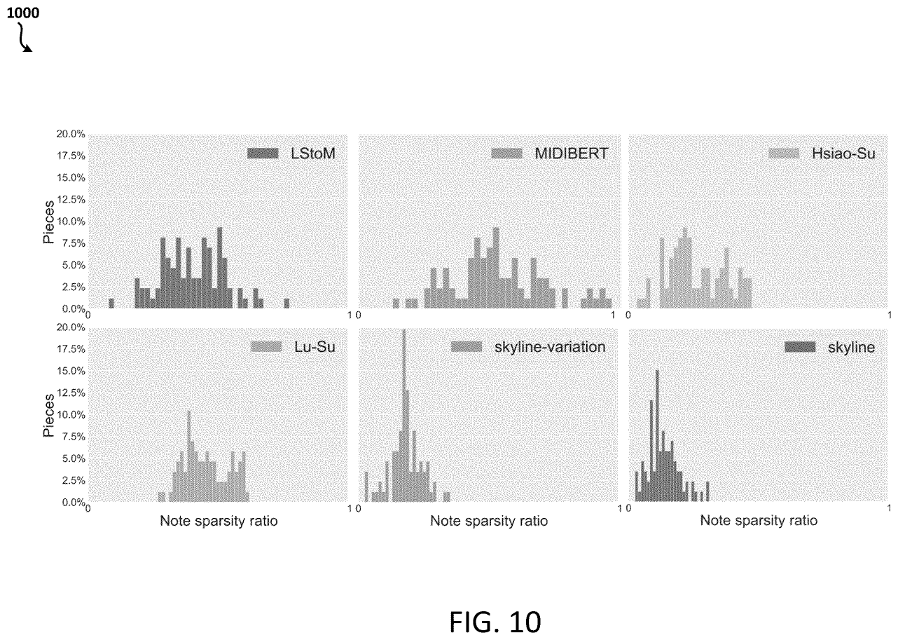

At 704, a performance of the model may be evaluated. The performance of the model may be evaluated using statistic metrics. The statistic metrics may comprise sparsity and pitch interval of consecutive notes (e.g., pitch interval distribution). The sparsity metric may indicate the ratio or percentage of the total duration of the silent parts over the total duration of the notes in a score. The pitch interval distribution metric may indicate the distribution of the note intervals among the consecutive melody note pairs. These statistic metrics are described in more detail below with regard to FIGS. 9-10.

The melody extraction model may have been set up after implementing a grid-search on the model hyper-parameters. After the set-up process, the melody extraction model may result in having 6 layers, with hidden size of 140, followed by a forward layer. The Adam optimizer may be used with a start learning rate of 0.001. The set of hyper-parameters that produce the highest melody F-measure score may be determined and selected. The melody F-measure score is discussed in more detail below with regard to Equation 4.

Regarding the training setup for the melody extraction model, in embodiments, data in the training-validation-test sets may correspond to a data percentage of 80-10-10%, respectively. The features were scaled, given the data points in the training and validation sets. The metrics that were computed for the melody extraction model comprise accuracy indicating the overall accuracy of the predicted notes in the form of a percentage, and a Voice False Alarm metric. The Voice False Alarm metric is defined as the number of notes incorrectly predicted as melody notes divided by the number of non-melody notes.

The metrics that were computed for the melody extraction model further comprise mel_{P} (e.g., melody notes precision score, as shown in Equation 2), mel_{R} (e.g., recall score, as shown in Equation 3), and mel_{P} (melody F-measure score, as shown in Equation 4). The accuracy of the melody extraction model may be improved by maximizing the melody F-measure score (i.e., mel_{P} as shown in Equation 4). At 706, the accuracy of the model may be improved by maximizing a melody F-measure score. The melody notes precision score, the recall score, and the melody F-measure score may be expressed as follows:

$${mel}_{P} = \frac{\vert Correctly predicted notes belonging to melody \vert}{\vert Notes predicted as belonging to melody \vert} \qquad Equation 2$$

$${mel}_{R} = \frac{\vert Correctly predicted notes belonging to melody \vert}{\vert Notes belonging to melody \vert} \qquad Equation 3$$

$${mel}_{F} = 2 ( \frac{{mel}_{P} * {mel}_{R}}{{mel}_{P} + {mel}_{R}} ) . \qquad Equation 4$$

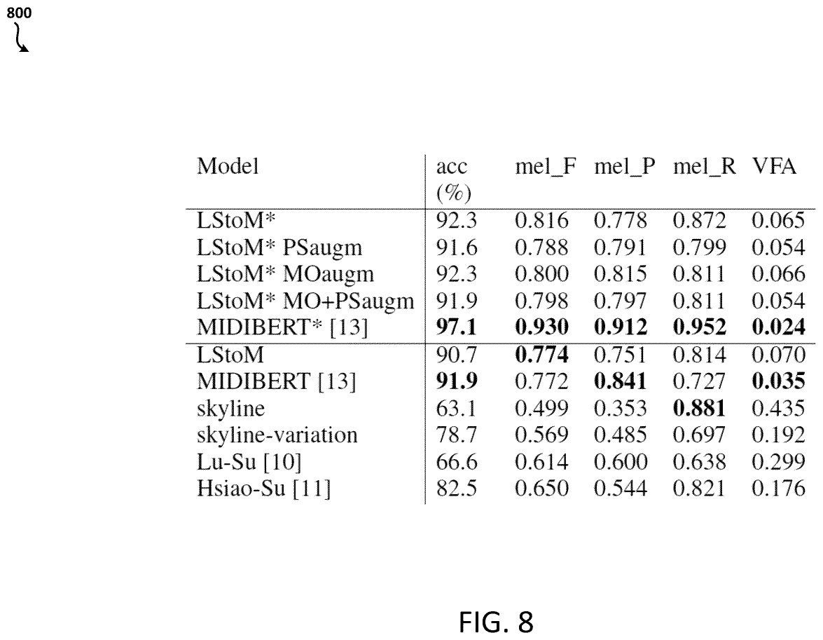

The melody extraction model 106 was evaluated to measure the effectiveness of several data augmentation techniques and to compare performance to other state-of-the-art models. FIG. 8 shows a table 800. The table 800 illustrates the results of comparing the melody extraction model 106 to other models. The melody extraction model 106 is referred to as LStoM herein. An ‘*’ is added to the table 800 next to models for which the MIDI files in the test set were pre-processed. The table 800 shows that the melody extraction model 106 approximates or outperforms current state of the art models trained on the same dataset, based on different implemented metrics and observations. To evaluate the performance of the melody extraction model 106, a list of separate model setups was prepared, given the same train, validation and test sets.

It was determined whether a first type of data augmentation technique would improve the accuracy of the melody extraction model 106 when applied in isolation. The first type of data augmentation technique comprises shifting the score key by altering the note pitches, where each piece has been transposed by n semitones, for n in {−6, −5, . . . , 4, 5}. The melody extraction model 106 with the first type of data augmentation technique is herein referred to as LStoM PSaugm. It was also determined whether a second type of data augmentation technique would improve the accuracy of the melody extraction model 106 when applied in isolation. The second type of data augmentation technique is to shift the melody notes one octave lower than the original one. The melody extraction model 106 with the second type of data augmentation technique is herein referred to as LStoM MOaugm. It was also determined whether the first and second data augmentation techniques, in combination with each other, would improve the accuracy of the melody extraction model 106.

It was investigated how models that report state of the art results in various datasets perform in the case of the specific train, validation and test sets. Two models were trained. One model was tailored to the task of melody identification using augmentation techniques and a pitch proximity method as a segment merging mode among the created note clusters (the model is herein referred to as “Hsiao-Su”). The other model was trained using augmentation techniques (the model is herein referred to as “Lu-Su”). The model herein referred to as the “skyline algorithm” essentially picks the highest pitch at a given onset time. The skyline algorithm was considered as the baseline. Additionally, a skyline variation where the duration of the note with the highest pitch was kept, ignoring the lower-pitch notes that start after its onset and before its offset was considered.

Both the melody extraction model 106 and the model referred to as “MIDIBERT” included pre-processing steps for note quantization and alignment in downbeat level when preparing the MIDI files for training. At the testing stage, the MIDI files of the test set were first pre-processed. Thus, the pre-processing steps were applied to the test set as well for the melody extraction model 106 and its augmentations. These metrics reported at the top part of the table 800. As shown in the table 800, the augmentations did not improve the overall performance of the melody extraction model 106. In the bottom part of the table 800, the metrics of the remaining comparisons are shown, where the notes of the test set were not quantized nor aligned to the downbeat. The melody extraction model 106 is significantly lighter than MIDIBERT, as the number of parameters being 875,462 compared to 111,298,052, respectively.

It was determined how important the selected features for the training process were with regard to the melody extraction model 106. It was determined whether any of the features (e.g., the six features described above) are more important in a sense that they contain an amount of information that is crucial for such systems. Algorithmically it is feasible to examine and improve the interpretability of a predictive model to a degree, and to identify a type of ranking of importance for the input features. However, most recent feature ranking algorithms assume feature independence, an assumption which is not safe with regard to the features described herein. One algorithm that is not based on this assumption is herein referred to as RELIEF. RELIEF elaborates on a simple comparison idea whereby feature value differences between nearest neighbor instance pairs are identified. If a feature value difference is observed in a neighboring instance pair with the same class, the feature ranking score decreases. However, the score increases when a feature value difference is observed in a neighboring instance pair with different class values. RELIEF was applied to the dataset described herein. The pitch was ranked as the most important feature, followed by the one that computes how much is the distance from the pitch above. The third feature in the ranking list is the similar one, computing the pitch distance from the pitch below. The note duration was the fourth most important features, followed by the metrical-related feature of computing the position of the note within the score bar. Last was the feature that indicates whether the note pitch is in scale.

In order to evaluate the incremental contribution of each of the features studied, feature subsets were considered by incrementally adding features to the training set one at a time, starting with the most important one, i.e., the note pitch, and continuing to add features according to their rank order. The highest ranked feature contains on its own substantial predictive power: the melody F-measure score for the melody extraction model 106 induced with only pitch information alone is 0.672, which is slighter higher than the one obtained by trainings on Hsiao-Su and Lu-Su systems. Interestingly, the precision is reduced by a very small margin and the voice alarm error value is slightly increased, when adding the feature pitch in scale, however the accuracy is increased at the same time.

Based on the predicted melodies by the melody extraction model 106, MIDIBERT, Hsiao-Su, Lu-Su and the baselines, two separate statistics may be highlighted. One statistic is the distribution of the note intervals among the consecutive melody note pairs. FIG. 9 shows a chart 900. The graph 900 illustrates a pitch interval distribution among melodies predicted by the melody extraction model 106, MIDIBERT, Hsiao-Su, Lu-Su, skyline and skyline-variation compared to the melodies from the test set. In FIG. 9, the x-axis has been limited to the range of around two and a half octaves for paper fitting purposes. As shown by the graph 900, the overall melodies predicted by the models tended to reflect characteristics from the original melody contour.

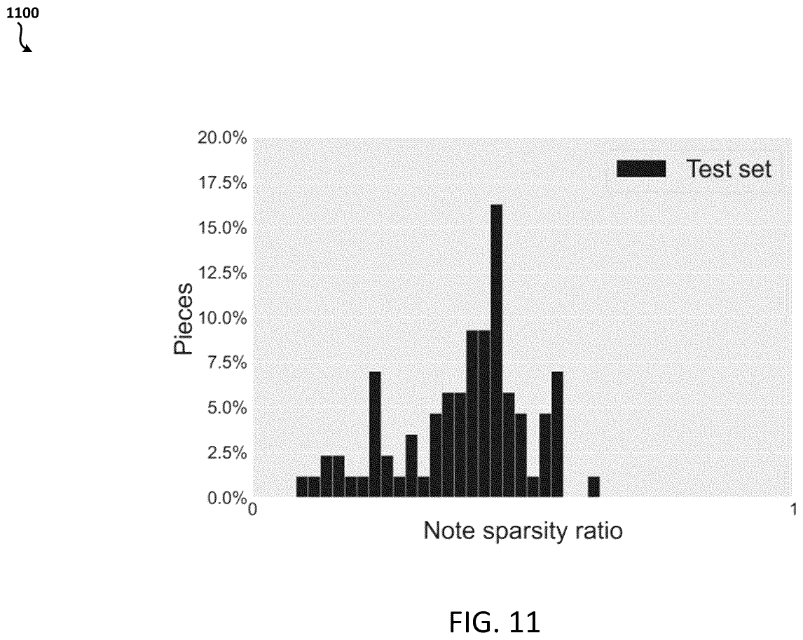

Another statistic is the percentage of predicted melodies with various degrees of sparsity in them. Sparsity means the ratio of the total duration of the silent parts over the total duration of the notes in a score. FIG. 10 shows a series of charts 1000. The series of charts 1000 illustrates the sparsity distribution among the predicted melodies. For example, the series of charts 1000 illustrates the sparsity distribution associated with the melody extraction model 106 (e.g., LStoM), and the sparsity distribution associated with five other models (MIDIBERT, Hsiao-Su, Lu-Su, skyline variation, and skyline). Only a small number of melodies from MIDIBERT tends to be sparser than the scores from the test set. FIG. 11 shows a chart 1100. The chart 1100 shows a sparsity ratio among melodies in the test set. As shown by the chart 1100 which highlights the ground truth from the test set, a small number of melodies from MIDIBERT tends to be sparser than the scores from the test set.

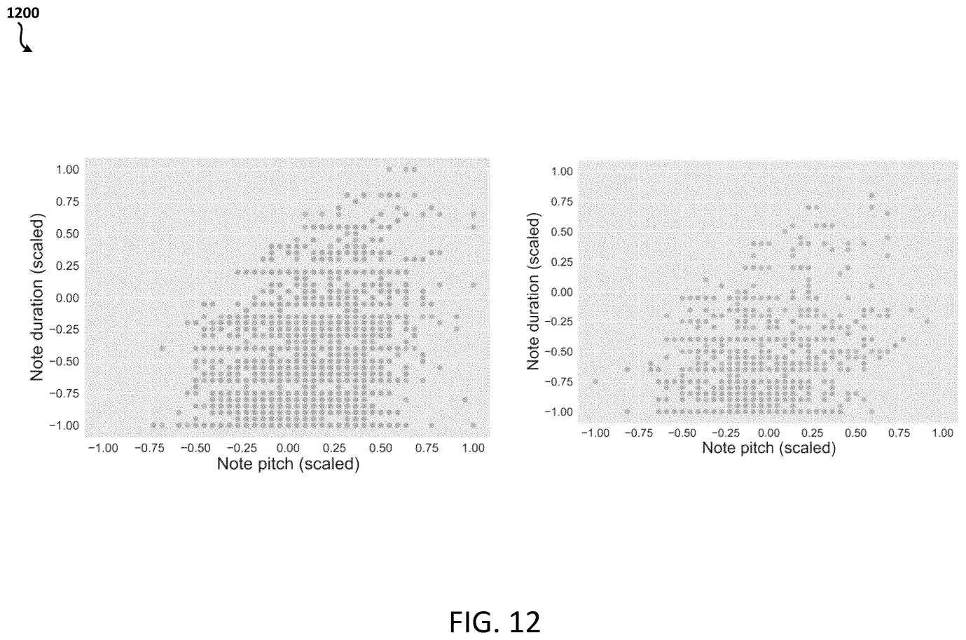

The most challenging melody notes to classify are those that are not the highest note (e.g., those that the skyline method would miss). The same test set where around 28% of the melody notes are such challenging cases was utilized. Of these, the melody extraction model 106 system classifies correctly around 82%. To investigate why sometimes such notes are not predicted as melody notes, the feature values of these true melody notes were scaled and distributions of features between the correctly labeled (i.e., retrieved) and incorrectly labeled (i.e., missed) notes were compared. One distribution that stood out is shown in FIG. 12.

FIG. 12 depicts a set of scatter plots 1200. The set of scatter plots 1200 shows the pitch and duration of the melody notes. The scatter plots 1200 show a scaled representation for the pitch-duration feature pair, for the melody notes that are not the highest note and have been predicted correctly (left scatter plot) or missed (right scatter plot). The set of scatter plots 1200 shows that, although the distributions are similar, there are many more correctly labeled notes with high pitch and long duration. Such findings indicate that disentangling such points is not trivial, if at all feasible with the current feature set alone.

The melody extraction model 106 described herein is a novel deep learning model for identifying the melody line from a polyphonic symbolic music. The key characteristics of the melody extraction model 106 are the input data representation as a set of features from the relevant task of multiple voice separation as well as the bidirectional nature of the architecture.

The bidirectional nature of the architecture provides information of future observations during the prediction process. The features were examined regarding their ability to contain the information that the melody extraction model 106 needs to predict a melody note more accurately. Also, two data augmentation techniques were examined in isolation. Results indicate that the proposed lightweight model which is trained and tested on a set of pop songs is capable of performing at the standard of existing benchmarks. Observations on the results reveal the ability of the melody extraction model 106 to reflect the concepts of score sparsity or the melodic pitch intervals from the test set. The melody extraction model 106 also performs well in situations where the melody note to be identified is not in the highest pitch of the score. In embodiments, the set of input features may be expanded. Note velocity information or metrical representation extracted from the dataset could accommodate additional features for the melody extraction model 106. Post-processing and/or denoising techniques may additionally be utilized to improve the results.

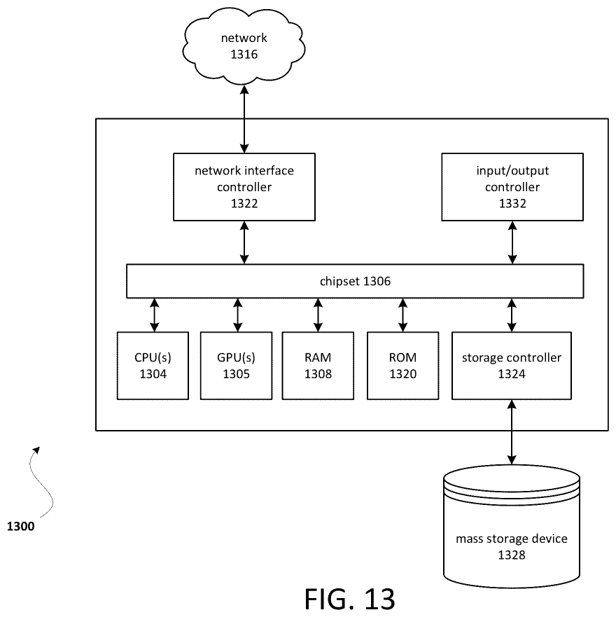

FIG. 13 illustrates a computing device that may be used in various aspects, such as the services, networks, modules, and/or devices depicted in FIG. 1. With regard to the example architecture of FIG. 1, any or all of the components may each be implemented by one or more instance of a computing device 1300 of FIG. 13. The computer architecture shown in FIG. 13 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1300 may include a baseboard, or “motherboard,” which is a printed circuit board to which a multitude of components or devices may be connected by way of a system bus or other electrical communication paths. One or more central processing units (CPUs) 1304 may operate in conjunction with a chipset 1306. The CPU(s) 1304 may be standard programmable processors that perform arithmetic and logical operations necessary for the operation of the computing device 1300.

The CPU(s) 1304 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1304 may be augmented with or replaced by other processing units, such as GPU(s). The GPU(s) may comprise processing units specialized for but not necessarily limited to highly parallel computations, such as graphics and other visualization-related processing.

A chipset 1306 may provide an interface between the CPU(s) 1304 and the remainder of the components and devices on the baseboard. The chipset 1306 may provide an interface to a random-access memory (RAM) 1308 used as the main memory in the computing device 1300. The chipset 1306 may further provide an interface to a computer-readable storage medium, such as a read-only memory (ROM) 1320 or non-volatile RAM (NVRAM) (not shown), for storing basic routines that may help to start up the computing device 1300 and to transfer information between the various components and devices. ROM 1320 or NVRAM may also store other software components necessary for the operation of the computing device 1300 in accordance with the aspects described herein.

The computing device 1300 may operate in a networked environment using logical connections to remote computing nodes and computer systems through local area network (LAN). The chipset 1306 may include functionality for providing network connectivity through a network interface controller (NIC) 1322, such as a gigabit Ethernet adapter. A NIC 1322 may be capable of connecting the computing device 1300 to other computing nodes over a network 1316. It should be appreciated that multiple NICs 1322 may be present in the computing device 1300, connecting the computing device to other types of networks and remote computer systems.

The computing device 1300 may be connected to a mass storage device 1328 that provides non-volatile storage for the computer. The mass storage device 1328 may store system programs, application programs, other program modules, and data, which have been described in greater detail herein. The mass storage device 1328 may be connected to the computing device 1300 through a storage controller 1324 connected to the chipset 1306. The mass storage device 1328 may consist of one or more physical storage units. The mass storage device 1328 may comprise a management component 1310. A storage controller 1324 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1300 may store data on the mass storage device 1328 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1328 is characterized as primary or secondary storage and the like.

For example, the computing device 1300 may store information to the mass storage device 1328 by issuing instructions through a storage controller 1324 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1300 may further read information from the mass storage device 1328 by detecting the physical states or characteristics of one or more particular locations within the physical storage units.

In addition to the mass storage device 1328 described above, the computing device 1300 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1300.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1328 depicted in FIG. 13, may store an operating system utilized to control the operation of the computing device 1300. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1328 may store other system or application programs and data utilized by the computing device 1300.

The mass storage device 1328 or other computer-readable storage media may also be encoded with computer-executable instructions, which, when loaded into the computing device 1300, transforms the computing device from a general-purpose computing system into a special-purpose computer capable of implementing the aspects described herein. These computer-executable instructions transform the computing device 1300 by specifying how the CPU(s) 1304 transition between states, as described above. The computing device 1300 may have access to computer-readable storage media storing computer-executable instructions, which, when executed by the computing device 1300, may perform the methods described herein.

A computing device, such as the computing device 1300 depicted in FIG. 13, may also include an input/output controller 1332 for receiving and processing input from a number of input devices, such as a keyboard, a mouse, a touchpad, a touch screen, an electronic stylus, or other type of input device. Similarly, an input/output controller 1332 may provide output to a display, such as a computer monitor, a flat-panel display, a digital projector, a printer, a plotter, or other type of output device. It will be appreciated that the computing device 1300 may not include all of the components shown in FIG. 13, may include other components that are not explicitly shown in FIG. 13, or may utilize an architecture completely different than that shown in FIG. 13.

As described herein, a computing device may be a physical computing device, such as the computing device 1300 of FIG. 13. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method for extracting a melody, comprising:
receiving a polyphonic symbolic music file, wherein the polyphonic symbolic music file comprises a plurality of notes;
converting the polyphonic symbolic music file to a plurality of feature vectors, wherein each of the plurality of feature vectors is a multidimensional vector, and wherein each of the plurality of feature vectors corresponds to a particular note of the plurality of notes; and
generating classifications of the plurality of feature vectors corresponding to the plurality of notes using a model, wherein the model is trained to determine whether each of the plurality of notes belongs to the melody based on the plurality of feature vectors.

2. The method of claim 1, further comprising:
constructing a musical instrument digital interface, MIDI, file corresponding to the melody based on the generated classifications.

3. The method of claim 1, wherein each of the plurality of feature vectors is a six-dimensional vector indicating features of pitch, duration, absolute pitch distance below, absolute pitch distance above, onset position in bar, and pitch in scale, the absolute pitch distance below feature representing a distance to a pitch of a neighboring lower note of the plurality of notes, the absolute pitch distance above feature representing a distance to a pitch of a neighboring higher note of the plurality of notes, the onset position in bar feature representing a score beat where a corresponding note onset is located within a score bar, and the pitch in scale feature indicating whether a pitch of a corresponding note of the plurality of notes is in a diatonic scale of a key signature.

4. The method of claim 1, wherein the model is a lightweight deep bidirectional long short-term memory, LSTM, model.

5. The method of claim 1, further comprising:
identifying note events indicative of attributes in response to receiving the polyphonic symbolic music file, wherein the attributes comprise start, duration, pitch, and track associated with the polyphonic symbolic music file;
consolidating the note events to a single list in response to identifying a plurality of tracks; and
extracting a time signature and a key signature associated with the polyphonic symbolic music file.

6. The method of claim 5, further comprising:
creating a time-grid associated with the plurality of notes by aligning note start times and adjusting note durations.

7. The method of claim 1, further comprising:
evaluating a performance of the model using statistic metrics of sparsity and pitch interval of consecutive notes.

8. The method of claim 1, wherein the model is trained with a focal loss function, the focal loss function configured to balance positive and negative samples.

9. The method of claim 8, wherein the focal loss function is defined as:
FL(pₜ)=−aₜ(1−pₜ)^{γ} log(pₜ),
wherein pₜ denotes an estimated probability of the model classifying an input to class t, wherein aₜ∈[0,1] represents a weighting factor to balance the positive and negative samples during training the model, and wherein (1−pₜ)^{γ} represents a modulating factor with γ controlling a rate at which over-weighted samples are down-weighted.

10. The method of claim 1, further comprising:
improving accuracy of the model by maximizing a melody F-measure score.

11. The method of claim 10, wherein the melody F-measure score is defined as
$${mel}_{F} = 2 ( \frac{{mel}_{P} * {mel}_{R}}{{mel}_{P} + {mel}_{R}} ) ,$$
wherein melₚ represents
$$\frac{\vert Correctly predicted notes belonging to melody \vert}{\vert Notes predicted as belonging to melody \vert} ,$$
and wherein mel_{R} represents
$$\frac{\vert Correctly predicted notes belonging to melody \vert}{\vert Notes belonging to melody \vert} .$$

12. A system of extracting a melody, comprising:
at least one processor; and
at least one memory communicatively coupled to the at least one processor and comprising computer-readable instructions that upon execution by the at least one processor cause the at least one processor to perform operations comprising:
receiving a polyphonic symbolic music file, wherein the polyphonic symbolic music file comprises a plurality of notes;
converting the polyphonic symbolic music file to a plurality of feature vectors, wherein each of the plurality of feature vectors is a multidimensional vector, and wherein each of the plurality of feature vectors corresponds to a particular note of the plurality of notes; and
generating classifications of the plurality of feature vectors corresponding to the plurality of notes using a model, wherein the model is trained to determine whether each of the plurality of notes belongs to the melody based on the plurality of feature vectors.

13. The system of claim 12, the operations further comprising:
constructing a musical instrument digital interface, MIDI, file corresponding to the melody based on the generated classifications.

14. The system of claim 12, wherein each of the plurality of feature vectors is a six-dimensional vector indicating features of pitch, duration, absolute pitch distance below, absolute pitch distance above, onset position in bar, and pitch in scale, the absolute pitch distance below feature representing a distance to a pitch of a neighboring lower note of the plurality of notes, the absolute pitch distance above feature representing a distance to a pitch of a neighboring higher note of the plurality of notes, the onset position in bar feature representing a score beat where a corresponding note onset is located within a score bar, and the pitch in scale feature indicating whether a pitch of a corresponding note of the plurality of notes is in a diatonic scale of a key signature.

15. The system of claim 12, the operations further comprising:
identifying note events indicative of attributes in response to receiving the polyphonic symbolic music file, wherein the attributes comprise start, duration, pitch, and track associated with the polyphonic symbolic music file;
consolidating the note events to a single list in response to identifying a plurality of tracks; and
extracting a time signature and a key signature associated with the polyphonic symbolic music file.

16. The system of claim 15, the operations further comprising:
creating a time-grid associated with the plurality of notes by aligning note start times and adjusting note durations.

17. The system of claim 12, the operations further comprising:
improving accuracy of the model by maximizing a melody F-measure score.

18. A non-transitory computer-readable storage medium, storing computer-readable instructions that upon execution by a processor cause the processor to implement operations comprising:
receiving a polyphonic symbolic music file, wherein the polyphonic symbolic music file comprises a plurality of notes;
converting the polyphonic symbolic music file to a plurality of feature vectors, wherein each of the plurality of feature vectors is a multidimensional vector, and wherein each of the plurality of feature vectors corresponds to a particular note of the plurality of notes; and
generating classifications of the plurality of feature vectors corresponding to the plurality of notes using a model, wherein the model is trained to determine whether each of each of the plurality of notes belongs to the melody based on the plurality of feature vectors.

19. The non-transitory computer-readable storage medium of claim 18, the operations further comprising:
constructing a musical instrument digital interface, MIDI, file corresponding to the melody based on the generated classifications.

20. The non-transitory computer-readable storage medium of claim 18, wherein each of the plurality of feature vectors is a six-dimensional vector indicating features of pitch, duration, absolute pitch distance below, absolute pitch distance above, onset position in bar, and pitch in scale, the absolute pitch distance below feature representing a distance to a pitch of a neighboring lower note of the plurality of notes, the absolute pitch distance above feature representing a distance to a pitch of a neighboring higher note of the plurality of notes, the onset position in bar feature representing a score beat where a corresponding note onset is located within a score bar, and the pitch in scale feature indicating whether a pitch of a corresponding note of the plurality of notes is in a diatonic scale of a key signature.
